(19) United States
(12) Patent Application Publication
(10) Pub. No.: US 2002/0074933 A1
(43) Pub. Date: Jun. 20, 2002

(54) Panel and implosion proof glass of flat color CRT and method for bonding thereof

(75) Inventors: Koo Hwa Lee, Kyongsangbuk-do (KR); Keun Pil Lee, Kyongsangbuk-do (KR); Young Ku Kim, Kyongsangbuk-do (KR)

Correspondence Address: FLESHNER & KIM, LLP, P.O. Box 221200, Chantilly, VA, 20153-1200, US

(73) Assignee: LG ELECTRONICS INC.

(21) Appl. No.: 09/984,322

(22) Filed: Oct. 29, 2001

(30) Foreign Application Priority Data
Nov. 2, 2000 (KR) 2000/64886
Jan. 10, 2001 (KR) 2001/1296
Feb. 13, 2001 (KR) 2001/7005

(51) Int. Cl. H01J 1/62; H01J 63/04

(52) U.S. Cl. 313/495; 445/24

(57) ABSTRACT

An object of the present invention is to provide a panel and an implosion proof glass of a flat color CRT, and a method for bonding thereof, in which a defective panel and a defective implosion proof glass from a fabrication process are refreshed by strengthening an adhesive force between the panel and the implosion glass and making to adjust the adhesive force to an appropriate level, for reducing a production cost, preventing environmental contamination, and improving focus and a contrast.

To achieve this, the present invention provides a panel and an implosion proof glass of a flat color CRT including a thermosetting resin disposed between the implosion proof glass and the panel, for providing adhesiveness between the implosion proof glass and the panel.

The present invention also provides a method for bonding a panel and an implosion proof glass of a flat color CRT, including the steps of (a) laying a thermosetting resin, and the implosion proof glass on an outside surface of the panel of the flat color CRT, (b) putting a vacuum band on edges of the layers of the panel, the thermosetting resin, and the implosion proof glass to enclose the edges of the layers, or placing the CRT in a vacuum chamber, (c) evacuating an enclosed space to form a vacuum therein, (d) conducting heating to soften the thermosetting resin, (e) compressing the thermosetting resin for eliminating a surface wave, and (f) conducting cooling down after the heating, and releasing the vacuum.

### BACKGROUND OF THE INVENTION

1. Field of the Invention

The present invention relates to a panel and an implosion proof glass of a flat color cathode ray tube, and more particularly, to a panel and an implosion proof glass of a flat color cathode ray tube (CRT) having a thermoplastic resin and a surfactant between the panel and the implosion proof glass, and a method for bonding thereof.

2. Background of the Related Art

Referring to FIG. 1, a related art color CRT is provided with a panel 1 having an implosion poof glass fitted on a front surface thereof, a funnel 3 welded to the panel 1, an electron gun 5 sealed in the funnel 3 for emitting R, G, B three electron beams 4 toward the panel 2, a fluorescent film 6 of R, G, B three color fluorescent materials coated on an inside surface of the panel 2 for emitting respective colors by the electron beams, and a rail 8 fitted to the panel 2 for keeping a fixed gap between a pre-stressed shadow mask 7 with a plurality of slits and the inside surface of the panel 2.

In the foregoing display, the panel 2 of glass is required to have a certain thickness for preventing inward collapse or implosion of the panel 2 caused by an external impact or a high internal vacuum, and avoiding occurrence of crack as the panel 2 is passed through a high temperature furnace during baking in a fabrication process, of which resistance against stress is the safer as the panel is the thicker, and is better if a curvature enough to distribute the stress is provided.

However, the thicker glass panel thickness results in a poor transmittivity with a poor efficiency of the display, such as poor luminance and the like, greater depth, and heavier weight, of the display, and a high cost. Therefore, while a thickness of the glass panel is maintained to an appropriate level, an implosion proof glass 1 is fitted to the front surface thereof for securing safety of users against breakage during use of the panel.

Particularly, as shown in FIG. 1, since the flat display can not distribute stress smoothly due to almost no curvature provided therein, a requirement for reinforcing is the greater. Of the implosion proof glass 1 or film used for the flat display, the implosion proof glass is used the most in view of quality as the implosion proof film gives a misty feeling that may deteriorates quality.

The bonding of the implosion proof glass 1 with the panel 2 is made by a lamination, when a fixed thickness and a high transmittivity, a gap, a bonding time period, adhesive force, no delamination, no pores, and no scratch are required, as well as reliabilities such as a light resistance, a heat resistance, and the like, and a high refractive index, a high workability, and a high safety. In the lamination, as shown in FIG. 2A, a UV setting resin 10 is used, which sets by a UV ray, mostly such as acrylate or polyester which has a short setting time period by the UV ray, rather than silicone which has a longer setting time period by heat. In general, the UV setting resin has oligomer, monomer, reactive diluents, coupling agent, initiator, and solvent, which shows different setting performance and properties depending on composition and materials in polymerization, and used for bonding the implosion proof glass, thereby maintaining a reliability of the display.

The bonding of the implosion proof glass and the panel by using the UV setting resin by means of a UV setting reaction has a high defective product ratio because an equipment for maintaining a fixed gap between the panel and the implosion proof glass and a space for mounting the equipment are required, and many process steps are required, such as a step for forming an enclosed space for filling a mixed liquid before a liquid UV setting resin is made to react, a step for injecting the liquid, steps of washing and setting, and the like.

Accordingly, the related art bonding of the implosion proof glass and the panel by using the UV setting resin has the following problems.

First, a spacer is required for maintaining the fixed gap between the panel and the implosion proof glass.

Second, the defective product ratio is high because of complex steps, as a step for forming the enclosed space for filling the UV setting resin, a step for injecting the UV setting resin, and the steps of washing and setting are required.

Third, it is preferable that thickness of the implosion proof glass and the UV setting resin layer are great for dispersing the external impact. However, the greater the thickness of the implosion proof glass and the UV setting resin layer, the more a UV ray absorption by the implosion proof glass and the UV setting resin layer, that makes a light transmittivity through the implosion proof glass poor. Consequently, there may be a difference of setting extents of the resin for the resin at the panel side and at the implosion proof glass side. If the polymerization of the resin at the panel side is imperfect, the film may have poor performance and form dapples.

Fourth, the UV setting resin is hazardous and has a high production cost.

### SUMMARY OF THE INVENTION

Accordingly, the present invention is directed to a panel and an implosion proof glass of a flat color CRT, and a method for bonding thereof that substantially obviates one or more of the problems due to limitations and disadvantages of the related art.

An object of the present invention is to provide a panel and an implosion proof glass of a flat color CRT, and a method for bonding thereof, in which a defective panel and a defective implosion proof glass from a fabrication process are refreshed for reducing a production cost, preventing environmental contamination, and improving focus and a contrast.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the panel and an implosion proof glass of a flat color CRT including a thermosetting resin disposed between the implosion proof glass and the panel, for providing adhesiveness between the implosion proof glass and the panel.

In other aspect of the present invention, there is provided with a method for bonding a panel and an implosion proof glass of a flat color CRT, including the steps of (a) laying a thermosetting resin, and the implosion proof glass on an outside surface of the panel of the flat color CRT, (b) putting a vacuum band on edges of the layers of the panel, the thermosetting resin, and the implosion proof glass to enclose the edges of the layers, or placing the CRT in a vacuum chamber, (c) evacuating an enclosed space to form a vacuum therein, (d) conducting heating to soften the thermosetting resin, (e) compressing the thermosetting resin for eliminating a surface wave, and (f) conducting cooling down after the heating, and releasing the vacuum.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a section of a related art color cathode ray tube;

FIGS. 2A and 2B illustrate sections each showing a related art bonded state of a panel and an implosion proof glass;

FIG. 3 illustrates a section showing a structure a safety glass is bonded to a panel by using a thermosetting resin in accordance with a preferred embodiment of the present invention;

FIGS. 4A and 4B illustrate sections each showing a bonded state of a panel and an implosion proof glass in accordance with a preferred embodiment of the present invention;

FIG. 5 illustrates a curve showing a concentration of surfactant of the present invention vs. a surface tension;

FIG. 6 illustrates a molecular structure of a dye;

FIG. 7A illustrates a spectrum when violet color dye is applied;

FIG. 7B illustrates a spectrum when green color dye is applied;

FIG. 7C illustrates a spectrum when red color dye is applied;

FIG. 7D illustrates a spectrum when blue color dye is applied;

FIG. 7E illustrates a spectrum when black color dye is applied;

FIG. 8 illustrates spectrums vs. concentrations of dyes;

FIG. 9 illustrates colors of dyes vs. body colors;

FIG. 10A illustrates variation of a spot size, a focusing characteristic, when 114 μmA is applied to red fluorescent material;

FIG. 10B illustrates variation of a spot size, a focusing characteristic, when 195 μmA is applied to red fluorescent material;

FIG. 11 illustrates a process for fabricating an implosion proof apparatus for a flat color CRT of the present invention; and,

FIGS. 12A and 12B illustrate plans each showing a surface condition of a thermosetting resin of the present invention.

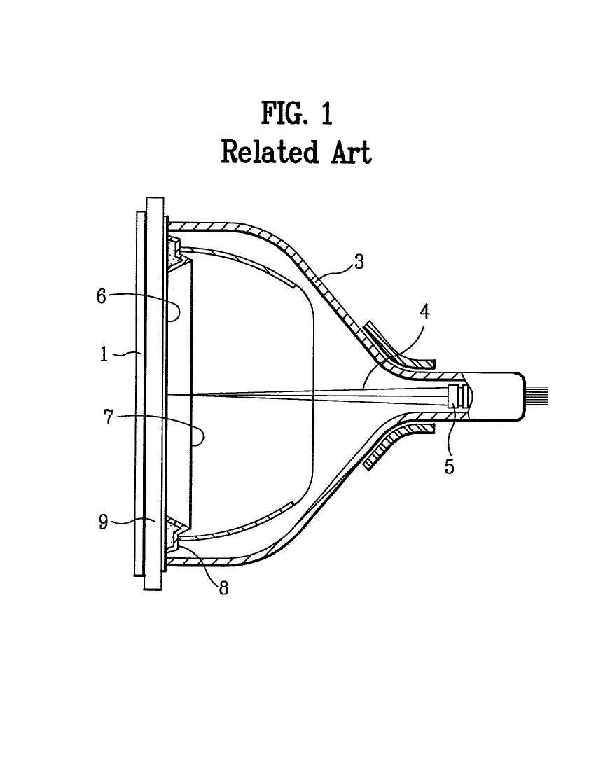

### DETAILED DESCRIPTION OF THE PREFERRED EMBODIMENT

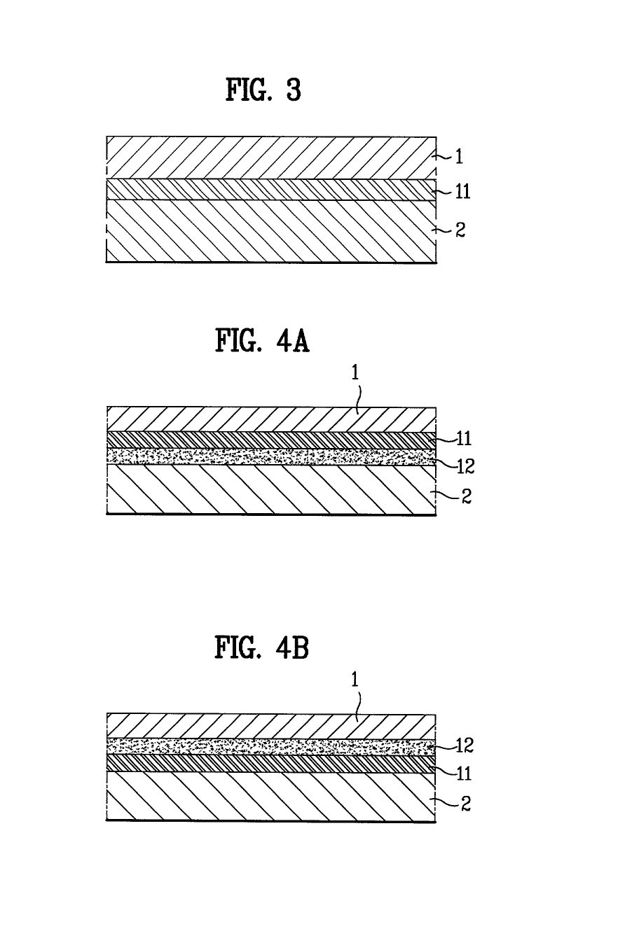

Reference will now be made in detail to the preferred embodiments of the present invention, examples of which are illustrated in the accompanying drawings. FIG. 3 illustrates a section showing a structure a safety glass is bonded to a panel by using a thermosetting resin in accordance with a preferred embodiment of the present invention.

Referring to FIG. 3, the structure of a panel side of a flat color CRT, in which a safety glass is bonded to a panel by using a thermosetting resin in accordance with a preferred embodiment of the present invention includes a panel 2, a coat of a thermosetting resin on an outside surface of the panel 2, and an implosion proof glass 1 bonded on the thermosetting resin 11. The thermosetting resin 11 is involved in no chemical transformation during a heating or cooling process, i.e., no molecular change. The thermosetting resin 11 is softened when heated to have plasticity, and is set again once cooled down. The thermosetting resin is formable owing to the plasticity.

Polyvinylbutyral, a polyvinylacetal group thermosetting resin used as the thermosetting resin 11 prepared by condensation polymerization of polyvinylalcohol and butylaldehyde, is colorless, and has a light transmittivity over 98%, a refractive index in a range of 1.47-1.5 similar to glass, and a density of 1.07. These properties serve to moderate an external impact to the color CRT if the polyvinylbutyral is used when the implosion proof glass and the panel is bonded.

The implosion proof glass 1 preferably has a thickness in a range of 1 mm-6 mm. At least 1 mm thickness is required for serving as an implosion proof glass, and a thickness greater than 6 mm is not preferable because a picture quality may be affected. The thermosetting resin 11 preferably has a rugged surface, and a thickness in a range of 0.3 mm-3 mm. The thicker the layer of the thermosetting resin, i.e., the polyvinylbutyral, an implosion effect is enhanced. The layer of the thermosetting resin with a thickness over 3 mm may runs down when the thermosetting resin is softened, costs high, and deteriorates the light transmittivity. Therefore, it is preferable that the layer of the thermosetting resin has a thickness in a range of 0.3 mm-3 mm.

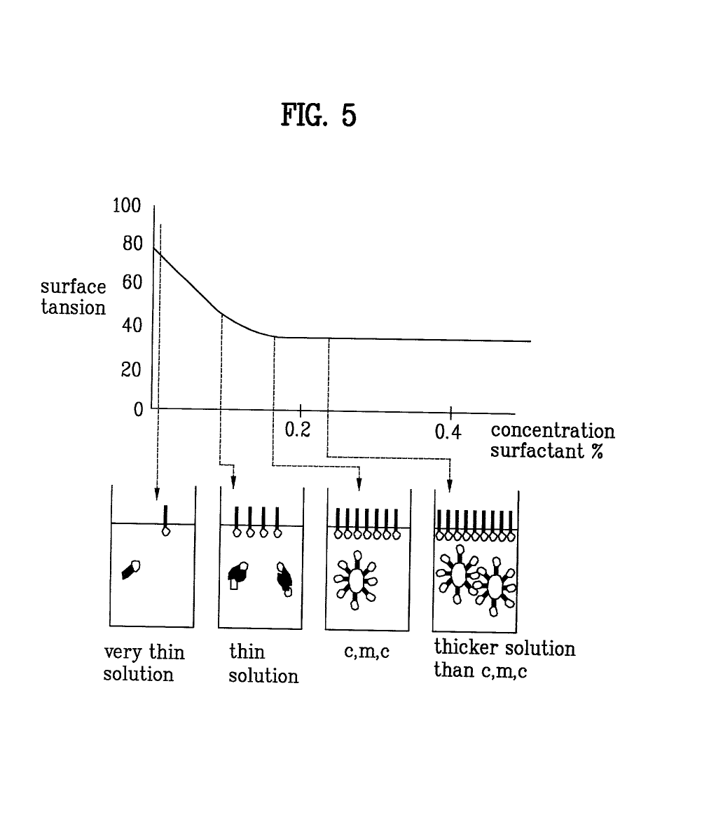

FIGS. 4A and 4B illustrate sections each showing a bonded state of a panel and an implosion proof glass in accordance with another preferred embodiment of the present invention, wherein a thermosetting resin layer 11 is formed between a panel 2 and an implosion proof glass 1, and, in addition to this, a surfactant 12 is formed between the thermosetting resin 11 on the implosion proof glass 1 and the panel 2 as shown in FIG. 4A, or between the thermosetting resin 11 on the panel 2 and the implosion proof glass 1 as shown in FIG. 4B.

In the present invention, a sheet form of the thermosetting resin with a thickness ranging 0.2-3 mm is placed between the implosion proof glass 1 and an outside surface of the panel 2, and heated for thermosetting. The thermosetting resin is preferable polyvinylbutyral (PVB) which has excellent optical properties and an impact buffering characteristic as shown in FIG. 3.

When the panel 2 and the implosion proof glass 1 are bonded by using the PVB sheet, the PVB sheet can not be removed for refreshment of the panel or the implosion proof glass by a generally known method due to too strong adhesive force of the PVB. As shown in FIGS. 4A and 4B, to cope with this, the present invention suggests to coat a surfactant 12 on the outside surface of the panel 2, or on the inside surface of the implosion proof glass 1, having the PVB coated thereon.

A concentration and coating amount of the surfactant 12 may be controlled appropriately for easy removal of the PVB sheet from the panel 1 or the implosion proof glass 1, for refreshment of the CRT. Because the surfactant 12 has hydrophilic and hydrophobic radicals gathering on a boundary surface that reduces a surface tension which serves to reduce a contact area, the adhesive force is reduced in comparison to the related art.

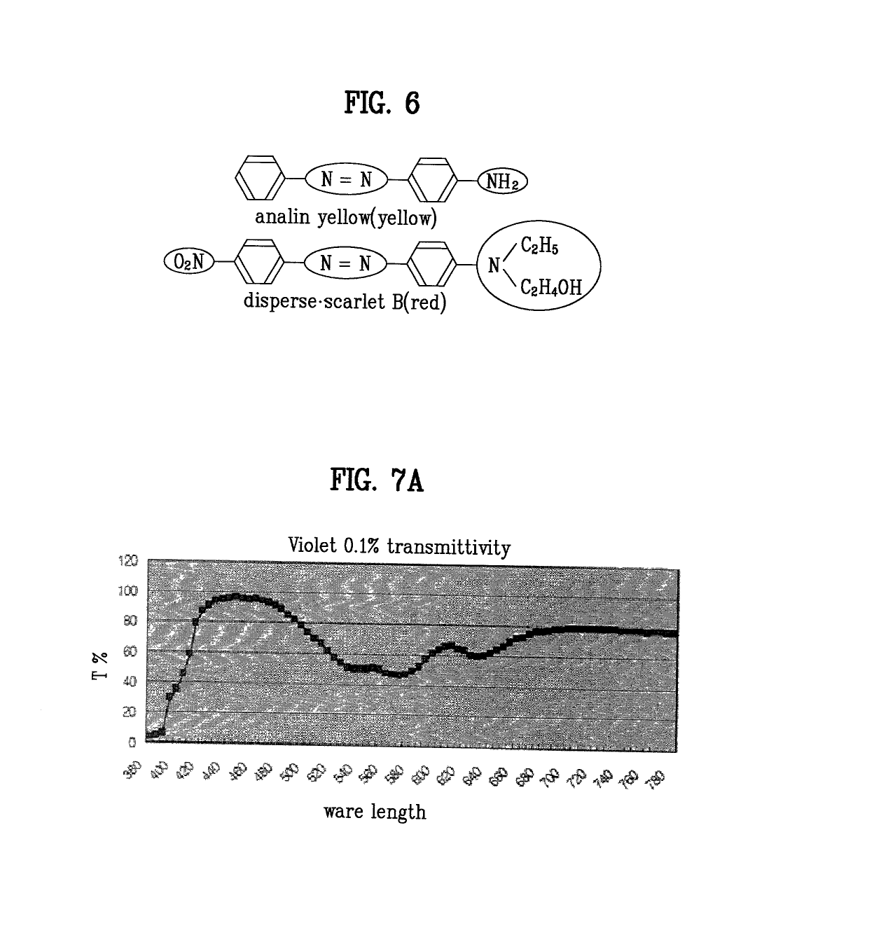

As surfactant composition, cations, such as K⁺, Na⁺, Mg²⁺, Ca²⁺, and the like, fluorine group, dimethyl, methyl (polyethylene oxide) siloxane copolymer, Lauryl acid soda, sodiumlauryl sulfate, nonylphenol, sodium octadecylsulfate, sodium octadecylsulfonate, tetrapropyl benzene sulfonate, and the like may be used. The cation makes a reaction with an OH radical to interfere an adhesion mechanism. The fluorine group has a low surface tension and is easy to peel. Excessive concentration, or amount of the surfactant 12 should be avoided, otherwise the implosion proof glass may fall off due to too weak adhesive force. In general, in the surfactant 12, the hydrophobic radicals are coupled with one another to form a group and move inward, and the hydrophilic radicals are coupled with one another to form a group and move outward. The group is called as ‘micelle’, and a concentration of the surfactant at the time is called as a micelle limiting concentration. Referring to FIG. 5, since an influence to the surface tension coming from the surfactant is not varied at a concentration over the limiting concentration, the concentration is managed to be below the limiting concentration. The present invention will be explained with reference to embodiments.

EMBODIMENT 1

A surfactant with composition of cations, such as K⁺, Na⁺, Mg²⁺, Ca²⁺, and the like, fluorine group, or dimethyl, methyl (polyethylene oxide) siloxane copolymer is coated on the outside surface of the panel in the lamination process, and the panel and the implosion proof glass are bonded by using PVB resin. In this instance, the PVB is 0.76 mm thick.

Then, a vacuum band is covered for gas tight sealing, and air is removed from spaces between the implosion proof glass and the resin layer, and between the resin layer and the panel by using a vacuum pump, to form a vacuum below 10 torr. Then, the PVB resin is heated for approx. 10 minutes at 120° C. by using an infrared heater, top of the implosion proof glass is pressed down by using a pneumatic cylinder, and the heated PVB resin is cooled down, and the vacuum is released. The following table 1 shows characteristics of the CRT of the present invention.

TABLE 1

| | | 1* | 2* | 3* | 4* | Hazard | 5* | cost |
|---|---|---|---|---|---|---|---|---|
| The related | 1 | good | 92 | good | 1.52 | With | yes | very |
| art | | | | | | | | expensive |
| | 2 | good | 94 | good | 1.50 | without | no | expensive |
| The present | | good | 93 | good | 1.50 | without | yes | inexpensive |
| invention | | | | | | | | |

1*: implosion proof performance,
2*: transmittivity (%),
3*: adhesive force,
4*: refractive index, and
5*: refreshment.

In table 1, the related art 1 denotes the case the UV ray setting resin is employed, and the related art 2 denotes the case the PVB sheet is employed, but without the surfactant.

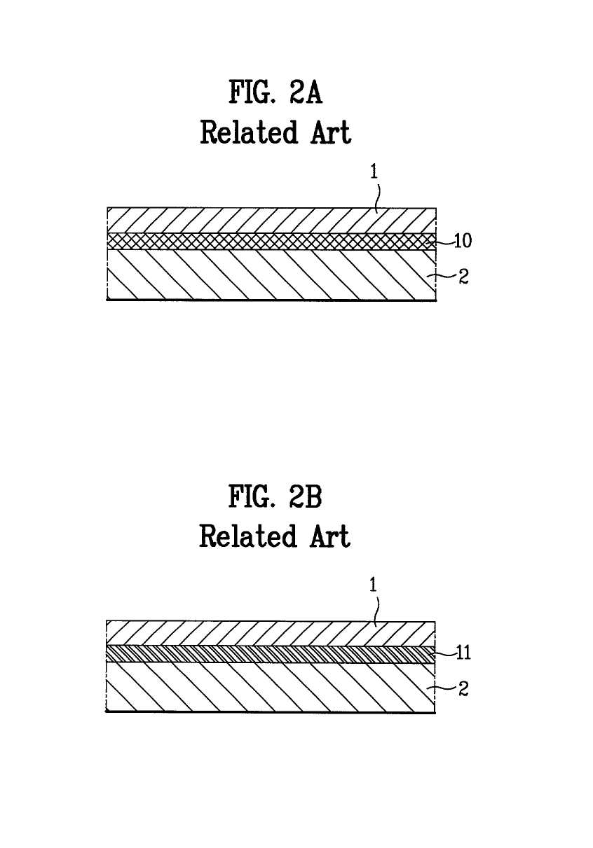

A pigment or dye of a visible range color may be added to the surfactant, whereas, since the related art UV ray setting resin (see 10 in FIG. 2A) is injected in a liquid state, no pigment can be added to the surfactant because the added pigment may form mottles or is involved in nature change.

In the meantime, of the evacuation, heating, and pressing steps required for bonding the PVB sheet, the evacuation step requires evacuation of air from spaces between the glass and the PVB sheet, for which the PVB sheet has a pattern with a certain groove and height. However, a too low height, with a close contact of the implosion proof glass to the PVB sheet, may make the evacuation difficult, and a too high height requires more time period for elimination of the pattern, which eliminates light scattering at the PVB sheet to appear transparent, and makes the fabrication process more difficult. However, a layer of the surfactant containing a pigment between the PVB sheet and the implosion poof glass, with a rugged surface provided between the PVB sheet and the glass, facilitates an easy evacuation of air from spaces between the glass and the PVB sheet, that permits to shorten the bonding step.

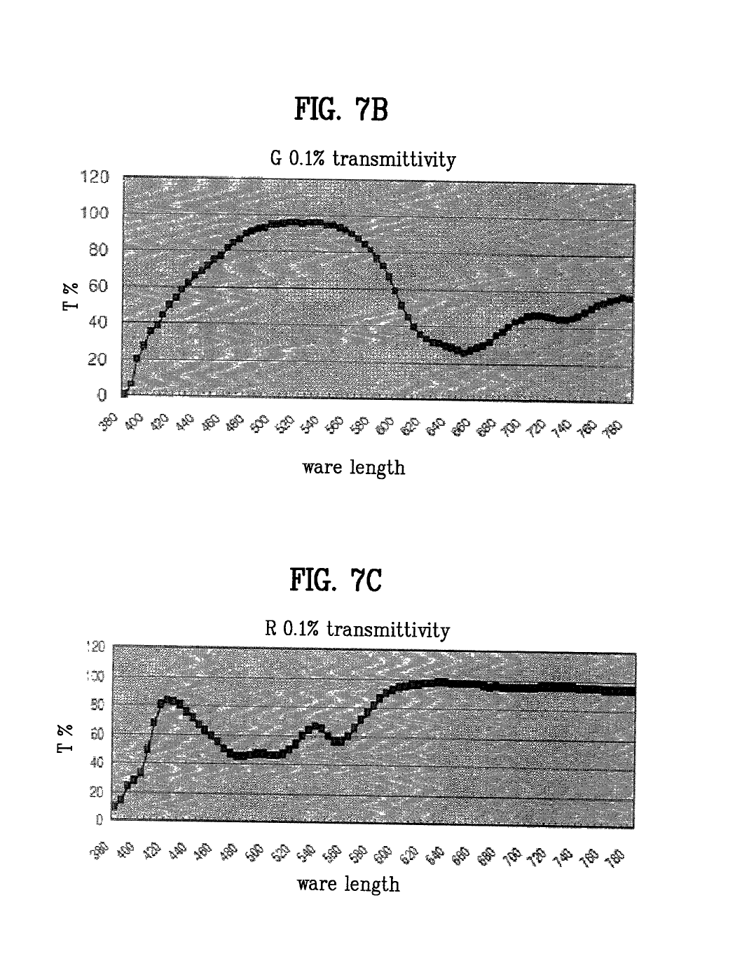

The surfactant may be colored by inorganic pigments, organic pigments, or dyes. Though the dyes in FIG. 6 have excellent coloring performance and dispersability, since the dyes have a poor light resistance, a poor heat resistance to be denatured at a temperature within 100° C., and a poor masking capability for other color, the pigment is preferably employed.

There are many kinds of pigments. Though there are many kinds of organic pigments which are not dissolvable in solvent, such as water or oil, and through there are many kinds of organic coloring materials, used in a state the coloring material is dispersed in a medium, which have clear color tones, high coloring capabilities, excellent in transparency, and excellent light resistances, the organic pigments are inferior to the inorganic pigments.

The inorganic pigments of inorganic compounds, called as mineral pigments, are substantially stable in color compared to the organic pigments, and have good light, and heat resistances, but not transparent, and inadequate in concentration.

Processes for preventing deposition, and securing a dispersability are required in a case the pigment is added to the surfactant; for preventing the deposition, a wetting process is carried out, in which the liquid surfactant is wetted on solid neighbors, and, for securing the dispersability, the pigment in solid lumps is powdered into particles by milling and the like so that the pigment is dispersed into the surfactant.

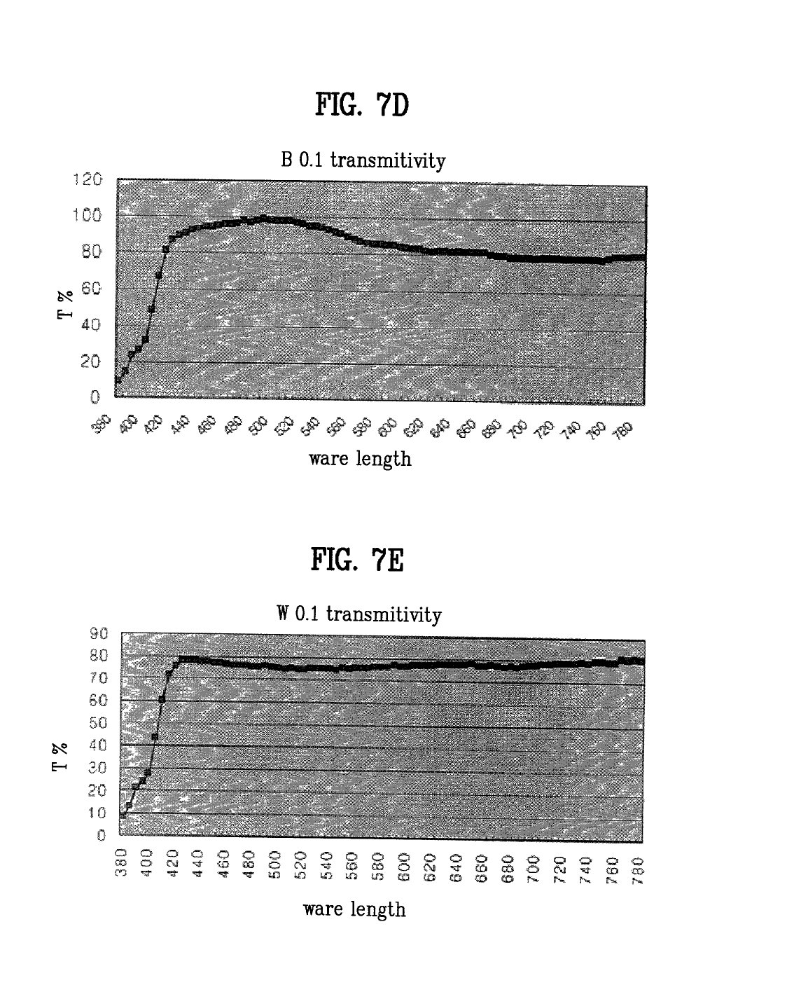

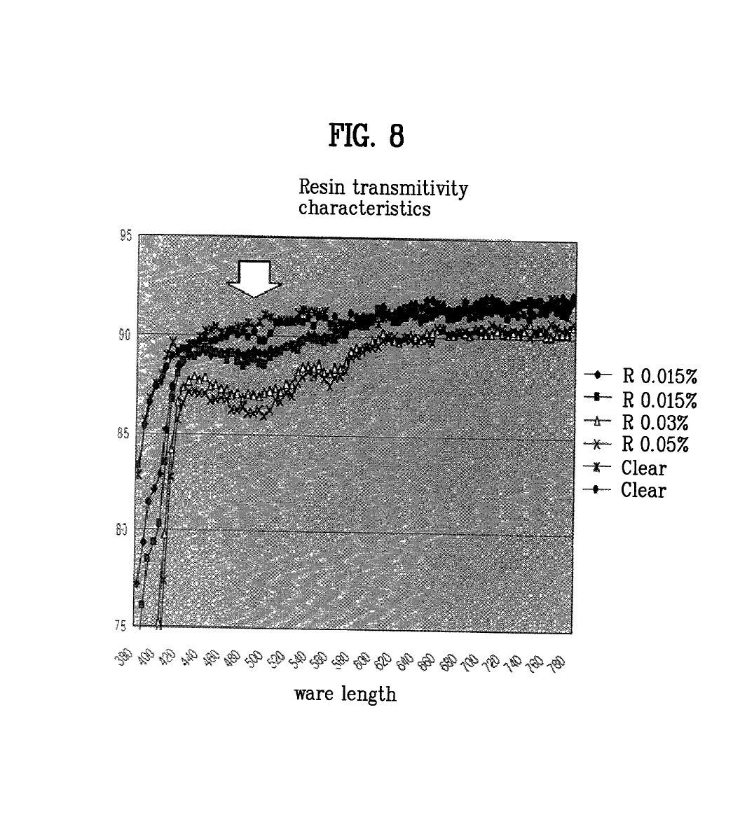

As surfactant composition, materials described in detail in association with FIGS. 4A and 4B may be employed. If pigment is thus added to the surfactant, spectrum varies with pigment colors within a 380-780 mn visible light range of wavelengths. FIGS. 7A-7E illustrate spectrums when different color dyes are applied to surfactant, wherefrom it can be known that luminance and contrast characteristics are dependent on spectrum characteristics. FIG. 8 illustrates spectrums vs. concentrations of dyes when the dye is added to the surfactant, wherefrom it can be known that, as a pigment concentration is proportional to a thickness of the surfactant, color, and spectrum characteristics can be adjusted by adjusting the concentration and the thickness even with the same pigment, thereby adjusting the luminance and contrast.

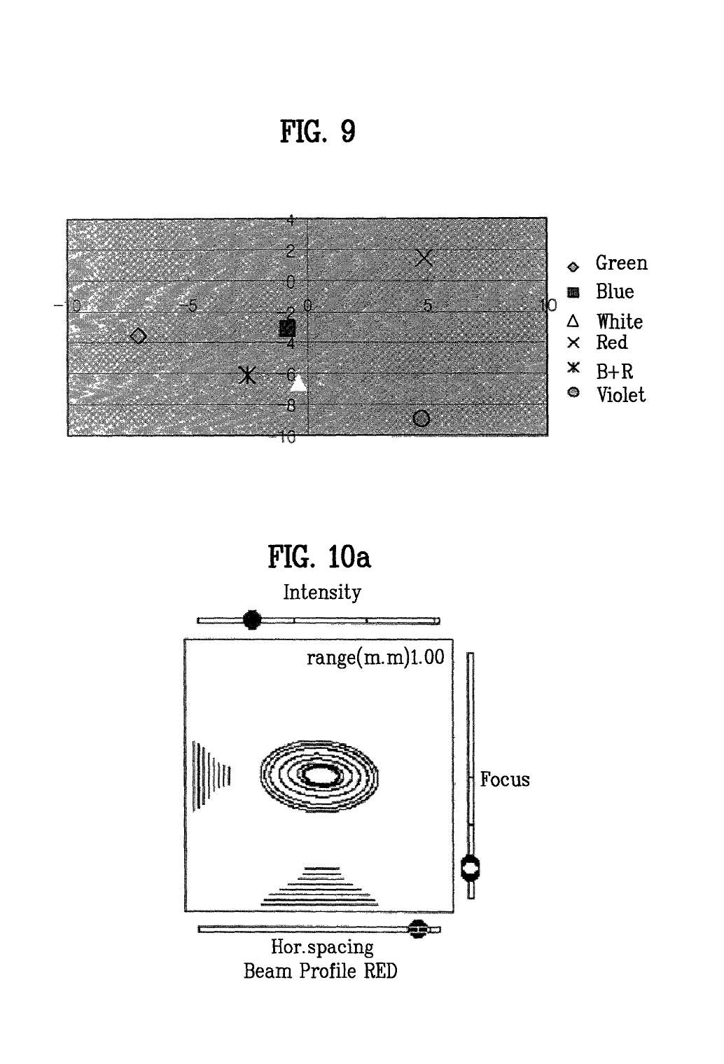

Thus, by means of the surfactant added with pigment, a desired body color can be adjusted. FIG. 9 illustrates colors of dyes vs. body colors. The following table 2 shows a measurement result of body colors on an La*b* coordinate, of a display fabricated by mixing pigment and surfactant.

TABLE 2

| SPL | violet | green | blue | white | Red | R + B |
|---|---|---|---|---|---|---|
| L | 16.76 | 16.245 | 14.525 | 22.585 | 15.41 | 17.76 |
| a* | 4.78 | −7.05 | −0.865 | −0.385 | 4.88 | −2.525 |
| b* | −8.895 | −3.57 | −3.07 | −6.55 | 1.525 | −6.085 |

*The La*b* coordinate system is a color space for measuring a color of a body, wherein ‘L’ denotes a reflective luminance, representing the more achromatic as it goes the more to a central part, and ‘a*’ and ‘b’ represent color coordinates with reference to tristimulus values of a perfect reflector.

By adjusting the body color, a color sense for a desired color can be improved, to secure a balance of an unbalanced IK ratio. For an example, when an IK overcurrent is applied to a red fluorescent material, a resin added with a red pigment of an iron oxide group is employed, to enhance a red color feeling, that adjusts the IK ratio, for preventing an overload on red color.

Thus, first of all, by securing balance of the IK ratio, the overloaded focus and color purity characteristics are improved, of which improvement of the focus characteristics may be verified by the reduction of a spot size when the IK current overloaded on red color is reduced.

Also, by securing balance of the IK ratio, degradation of an overloaded fluorescent material, and occurrence of a lifetime problem can be prevented. Particularly, a red fluorescent material which uses a rare earth metal as a core is the most susceptible to burning and overcurrent with regard to the color coordinate. Moreover, a reduction of overload on a R side and stabilized cathodes in the gun prolong lifetimes of components.

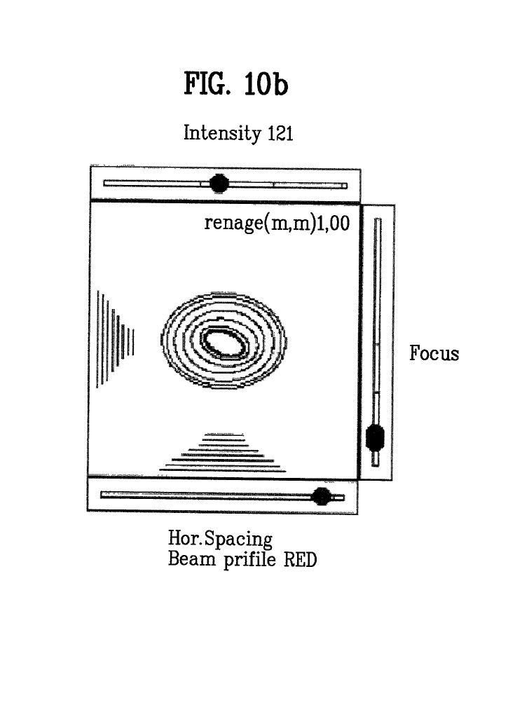

FIGS. 10A and 10B illustrate variations of spot sizes each showing a better focusing as the IK current is the smaller, wherefrom it can be known that the reduction of overloaded current on the fluorescent material improves the focusing. As can be known from spectrum characteristics, reduction of transmittivities of undesirable color parts improves contrast.

As has been explained, by coloring the panel or the implosion proof glass, the present invention permits unrestricted adjustment of a transmittivity while reducing cost in comparison to the related art adjustment method, and can improve contrast without deterioration of optical characteristics, such as luminance and the like, by using spectrum characteristics. By using at least one pigment, a user desired body color can be implemented, of which color is adjustable by adjustment of an amount and thickness of the pigment.

As a large amount of pigment may deteriorate the luminance characteristics excessively, harmony with an appropriate body color is required. By using a clear panel with an approx. 90% transmittivity, with appropriate adjustment of concentration and thickness accordingly, in the adjustment of a spectrum, a high quality body color and an improvement of the contrast characteristics can be achieved without deterioration of the luminance. Though the luminance may drop due to reduction of transmittivity of the colored resin, a G load current increase owing to the IK ratio balance and an improvement of a luminance efficiency of the fluorescent material can offset the luminance drop. Moreover, by enhancing a color feeling for a lack color side, both improvement of the IK ratio and enhancement of the color feeling can be secured.

It is preferable that the concentration of the coloring pigment added to the surfactant is in a range of 0.0001-0.5%, and a thickness of the surfactant layer is 0.005-1.0 mm.

EMBODIMENT 2

An appropriate concentration of surfactant with composition of dimethyl, methyl (polyethylene oxide) siloxane copolymer containing 0.015% of red organic pigment is sprayed on the outside surface of the panel in the lamination process, and the panel having a coat of the surfactant formed thereon and the implosion proof glass are bonded by using PVB resin. In this instance, the pigment is subjected to milling, and wetting agent processing so that the pigment is dispersed in the surfactant uniformly, and the PVB is 0.76 mm thick.

Then, a vacuum band is covered for gas tight sealing, and air is removed from spaces between the implosion proof glass and the PVB resin layer, and between the PVB resin layer and the panel by using a vacuum pump, to form a vacuum below 10 torr. Then, the PVB resin is heated for approx. 10 minutes at 120° C. by using an infrared heater, top of the implosion proof glass is pressed down by using a pneumatic cylinder, and the heated PVB resin is cooled down, and the vacuum is released. The following table 3 shows characteristics of the CRT having the panel fabricated thus is applied thereto.

TABLE 3

| | IK ratio | | Luminance | Contrast |
|---|---|---|---|---|
| | R/G | R/B | (500 μA/FL) | 200 lux |
| The related art 1 | 1.42 | 1.34 | 28.8 | 18.7 |
| The related art 2 | 1.41 | 1.32 | 28.8 | 18.7 |
| Embodiment | 1.15(20%) | 1.12(16%) | 29.4(102.3%) | 20.8(111%) |

In the table 3, the related art 1 denotes the case the UV ray setting resin is employed, and the related art 2 denotes the case the PVB sheet is employed, but without the surfactant.

As shown in table 3, the embodiment improves ratios of R/G, and R/B by 20%, and 16% respectively, which are references of unbalance of the IK ratio with respect to R, G, and B. Ideal RIG and R/B ratios are ‘1’. Also, as the current overloaded to a R side is dispersed to a G side which has a high luminance, the luminance is improved by 2.3% in the embodiment of the present invention in comparison to the related art, and as the pigment is added to the resin, which adjusts a transmittivity of the resin, contrast is enhanced by 11%. The evacuation process for removal of air from spaces between the glass and the PVB sheet for bonding the PVB sheet is shorted to 3 minutes from 5 minutes in the related art, to reduce by 40%.

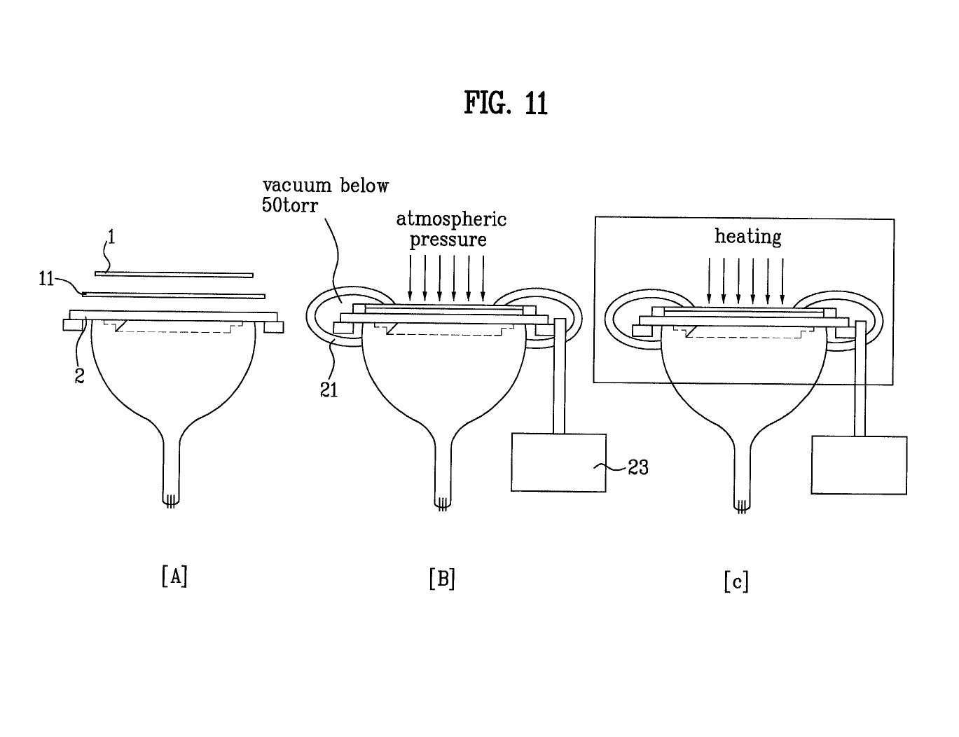

A method for bonding the panel and the implosion glass in accordance with a preferred embodiment of the present invention will be explained, with reference to FIG. 11.

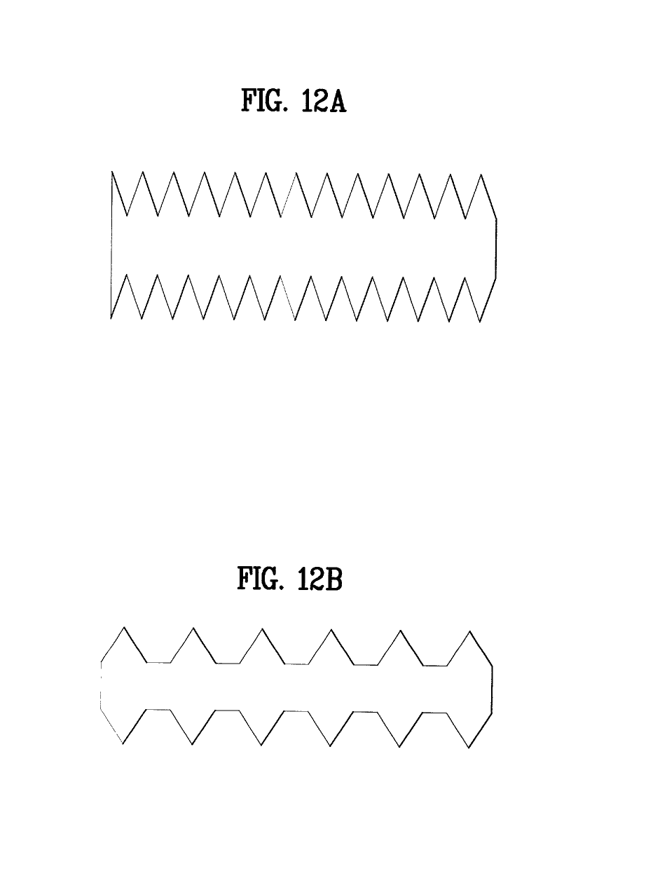

Referring to FIG. 11[A], a sheet 11 of PVB thermosetting resin having a wavy surface and an implosion proof glass 1 are laid on a panel 2 of a color CRT in succession. The sheet 11 may have a variety of forms as shown in FIGS. 12A and 12B. The foregoing surfactant 12 added with the pigment or the dyes may be coated on an outside surface of the panel 2, or on an inside surface of the implosion proof glass 1 in advance.

Referring to FIG. 11[B], edges of the panel, the sheet, and the implosion proof glass are enclosed with a vacuum band 21, and the enclosed space is evacuated by a vacuum pump 23 to a vacuum below 50 torr. The vacuum band 21 is preferably formed of silicone rubber having an excellent heat-resistance and elasticity. The evacuation from spaces between layers prevents formation of pores. Since the wavy surface of the PVB sheet 11 serves as passages of air during evacuation, the air between the layers can be removed, completely.

Referring to FIG. 11[C], the layers are heated under vacuum for 10-30 minutes at 120-140° C. by using a UV ray heater, or a heating oven, leading the PVB sheet softened, and compressed under atmospheric pressure, to cause deformation of the wavy surface, resulting to form a transparent PVB sheet. After formation of the transparent sheet, the panel and the implosion proof glass are bonded through the steps of cooling and vacuum releasing.

It will be apparent to those skilled in the art that various modifications and variations can be made in the panel and an implosion proof glass of a flat color CRT, and a method for bonding thereof of the present invention without departing from the spirit or scope of the invention. Thus, it is intended that the present invention cover the modifications and variations of this invention provided they come within the scope of the appended claims and their equivalents.

What is claimed is:

1. A panel and an implosion proof glass of a flat color cathode ray tube (CRT), comprising:
a thermosetting resin disposed between the implosion proof glass and the panel, for providing adhesiveness between the implosion proof glass and the panel.

2. A panel and an implosion proof glass as claimed in claim 1, further comprising a surfactant layer between the thermosetting resin and the panel, or the thermosetting resin and the implosion proof glass.

3. A panel and an implosion proof glass as claimed in claim 1, wherein the surfactant contains a pigment or a dye.

4. A panel and an implosion proof glass as claimed in claim 1, wherein the implosion proof glass is 1 mm-6 mm thick.

5. A panel and an implosion proof glass as claimed in claim 1, wherein the thermosetting resin is polyvinylbutyral.

6. A panel and an implosion proof glass as claimed in claim 1, wherein the thermosetting resin is 0.2 mm-3 mm thick.

7. A panel and an implosion proof glass as claimed in claim 1, wherein the thermosetting resin has a form of sheet having a wavy surface.

8. A panel and an implosion proof glass as claimed in claim 2, wherein the surfactant has composition at least one selected from cations, such as K⁺, Na⁺, Mg²⁺, Ca²⁺, and the like, fluorine group, dimethyl, methyl (polyethylene oxide) siloxane copolymer, Lauryl acid soda, sodiumlauryl sulfate, nonylphenol, sodium octadecylsulfate, sodium octadecylsulfonate, tetrapropyl benzene sulfonate.

9. A panel and an implosion proof glass as claimed in claim 3, wherein the pigment or the dye has a color within a visible range.

10. A panel and an implosion proof glass as claimed in claim 3, wherein the pigment is at least one selected from colors of violet, red, green, blue, yellow, and white.

11. A panel and an implosion proof glass as claimed in claim 3, wherein the pigment has a concentration of 0.0001-0.5%.

12. A panel and an implosion proof glass as claimed in claim 3, wherein the surfactant layer containing the pigment is 0.001-1.0 mm thick.

13. A method for bonding a panel and an implosion proof glass of a flat color cathode ray tube (CRT), comprising the steps of:
(a) laying a thermosetting resin, and the implosion proof glass on an outside surface of the panel of the flat color CRT;
(b) putting a vacuum band on edges of the layers of the panel, the thermosetting resin, and the implosion proof glass to enclose the edges of the layers, or placing the CRT in a vacuum chamber;
(c) evacuating an enclosed space to form a vacuum therein;
(d) conducting heating to soften the thermosetting resin;
(e) compressing the thermosetting resin for eliminating a surface wave; and,
(f) conducting cooling down after the heating, and releasing the vacuum.

14. A method as claimed in claim 13, wherein the vacuum is below 50 torr.

15. A method as claimed in claim 13, further comprising the step of forming a surfactant layer between the panel and the thermosetting resin or between the implosion proof glass and the thermosetting resin.

16. A method as claimed in claim 15, wherein the surfactant contains a pigment or a dye.

17. A method as claimed in claim 13, wherein the thermosetting resin h as a wavy surface.
